(19) United States
(12) Patent Application Publication
(10) Pub. No.: US 2021/0126793 A1
(43) Pub. Date: Apr. 29, 2021

(54) METHOD, SYSTEM AND NON-TRANSITORY COMPUTER-READABLE RECORDING MEDIUM FOR SUPPORTING NON-FACE-TO-FACE AUTHENTICATION IN A BLOCKCHAIN NETWORK

(71) Applicant: MediBloc Co., Ltd., Seoul (KR)

(72) Inventors: Woo Kyun KHO, Seoul (KR); Eun Sol LEE, Seoul (KR); Hee Kyu KIM, Anyang-si (KR); Min Kyoo CHA, Seoul (KR); Da Gang SEO, Seoul (KR)

(73) Assignee: MediBloc Co., Ltd., Seoul (KR)

(21) Appl. No.: 17/082,341

(22) Filed: Oct. 28, 2020

(30) Foreign Application Priority Data
Oct. 28, 2019 (KR) 10-2019-0134780

(51) Int. Cl. H04L 9/32; H04L 9/30

(52) U.S. Cl. CPC H04L 9/3226; H04L 2209/38; H04L 9/30; H04L 9/3247

(57) ABSTRACT

According to one aspect of the present invention, there is provided a method for supporting non-face-to-face authentication in a blockchain network, the method comprising the steps of: providing an authenticatee node with authentication result information generated as face-to-face authentication for personal information of an authenticatee is performed by at least one authenticator node in a blockchain network, and matching and recording non-invertible operation information on at least a part of the authentication result information to an account associated with the authenticatee in the blockchain network; and when a request for non-face-to-face authentication of the authenticatee is made by an authentication requester node, verifying validity of information for authentication, which is provided from the authentication requester node for the request for the non-face-to-face authentication of the authenticatee, on the basis of the non-invertible operation information recorded in the blockchain network.

### FIELD OF THE INVENTION

The present invention relates to a method, system, and non-transitory computer-readable recording medium for supporting non-face-to-face authentication in a blockchain network.

### BACKGROUND

Online markets based on non-face-to-face authentication have become active with the development of information technology. The non-face-to-face authentication is mainly performed through documents issued by publicly trusted institutions, such as identification cards and passports.

As an example of related conventional techniques, Korean Patent Laid-Open Publication No. 2019-7859 discloses a passport-based non-face-to-face real name authentication system, comprising: a financial management server configured to receive a customer's request for non-face-to-face real name verification from a partner company server, provide entered information on the customer to a bank server, and transmit a text message guide and a request for a passport image to the customer; and a data source server configured to receive and verify the passport image from the financial management server, wherein the financial management server is configured to verify a real name of the customer using the customer's mobile phone number, account number, real name, English name, and passport image obtained from the customer, the partner company server, and the data source server.

However, the techniques introduced so far, as well as the above-described conventional technique, are insecure or vulnerable to hacking because information for non-face-to-face authentication is integrated and managed by a centralized institution, and cause inconvenience because a document or certificate for non-face-to-face authentication should be received through a specific issuing institution with public trust.

Meanwhile, blockchain technology has emerged in recent years which can guarantee trust and security together even without a centralized server.

In this connection, the inventor(s) present a novel and inventive technique capable of integrating and managing results of face-to-face authentication performed as a user visits several institutions (e.g., hospitals) on the basis of blockchain technology, so that the results may be used for non-face-to-face authentication of the user, even when there is no separate certificate issued through a publicly trusted institution.

### SUMMARY OF THE INVENTION

One object of the present invention is to solve all the above-described problems in the prior art.

Another object of the invention is to perform non-face-to-face authentication on the basis of face-to-face authentication results recorded in a blockchain network.

Yet another object of the invention is to perform non-face-to-face authentication by comparing information recorded in a blockchain network with information provided from an authentication requester node to verify whether the information provided from the authentication requester node is valid.

Still another object of the invention is to evaluate the reliability for non-face-to-face authentication to be higher as there are more authenticators (or authenticator nodes) having authenticated an authenticatee face-to-face in a blockchain network, or as the reliability of the authenticators is higher.

Still yet another object of the invention is to prevent privacy invasion problems by recording only non-invertible operation information, or information by which a specific individual cannot be identified, in a blockchain network.

The representative configurations of the invention to achieve the above objects are described below.

According to one aspect of the invention, there is provided a method for supporting non-face-to-face authentication in a blockchain network, the method comprising the steps of: providing an authenticatee node with authentication result information generated as face-to-face authentication for personal information of an authenticatee is performed by at least one authenticator node in a blockchain network, and matching and recording non-invertible operation information on at least a part of the authentication result information to an account associated with the authenticatee in the blockchain network; and when a request for non-face-to-face authentication of the authenticatee is made by an authentication requester node, verifying validity of information for authentication, which is provided from the authentication requester node for the request for the non-face-to-face authentication of the authenticatee, on the basis of the non-invertible operation information recorded in the blockchain network.

According to another aspect of the invention, there is provided a system for supporting non-face-to-face authentication in a blockchain network, the system comprising: an authentication result information management unit configured to provide an authenticatee node with authentication result information generated as face-to-face authentication for personal information of an authenticatee is performed by at least one authenticator node in a blockchain network, and to match and record non-invertible operation information on at least a part of the authentication result information to an account associated with the authenticatee in the blockchain network; and a non-face-to-face authentication management unit configured to, when a request for non-face-to-face authentication of the authenticatee is made by an authentication requester node, verify validity of information for authentication, which is provided from the authentication requester node for the request for the non-face-to-face authentication of the authenticatee, on the basis of the non-invertible operation information recorded in the blockchain network.

In addition, there are further provided other methods and systems to implement the invention, as well as non-transitory computer-readable recording media having stored thereon computer programs for executing the methods.

According to the invention, it is possible to perform non-face-to-face authentication on the basis of face-to-face authentication results recorded in a blockchain network.

According to the invention, it is possible to perform non-face-to-face authentication by comparing information recorded in a blockchain network with information provided from an authentication requester node to verify whether the information provided from the authentication requester node is valid.

According to the invention, it is possible to evaluate the reliability for non-face-to-face authentication to be higher as there are more authenticators (or authenticator nodes) having authenticated an authenticatee face-to-face in a blockchain network, or as the reliability of the authenticators is higher.

According to the invention, it is possible to prevent privacy invasion problems by recording only non-invertible operation information, or information by which a specific individual cannot be identified, in a blockchain network.

### BRIEF DESCRIPTION OF THE DRAWINGS

FIG. 1 schematically shows the configuration of an entire system for performing non-face-to-face authentication based on a blockchain network according to one embodiment of the invention.

FIG. 2 illustratively shows a situation in which non-face-to-face authentication of an authenticatee is performed in a blockchain network according to one embodiment of the invention.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the locations or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the present invention will be described in detail with reference to the accompanying drawings to enable those skilled in the art to easily implement the invention.

Configuration of the Entire System

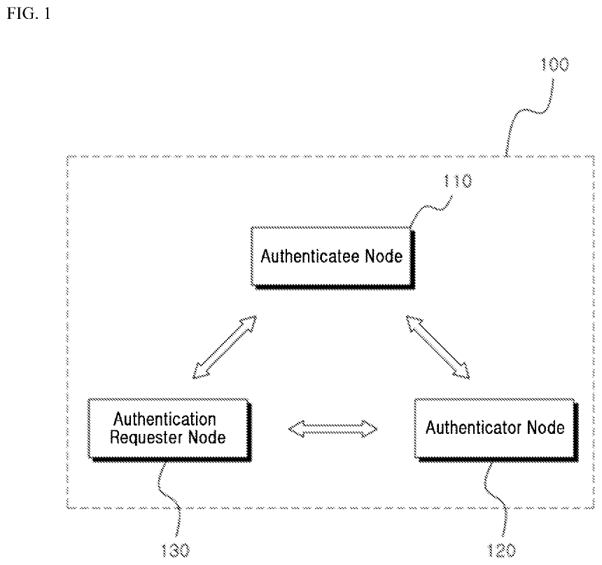

FIG. 1 schematically shows the configuration of the entire system for performing non-face-to-face authentication based on a blockchain network according to one embodiment of the invention.

As shown in FIG. 1, the entire system according to one embodiment of the invention may comprise a communication network and a plurality of nodes 100, and the nodes 100 may include an authenticatee node 110, an authenticator node 120, and an authentication requester node 130, for example.

First, the communication network according to one embodiment of the invention may be configured regardless of communication modality such as wired and wireless communications, and may be constructed from a variety of communication networks such as local area networks (LANs), metropolitan area networks (MANs), and wide area networks (WANs). Preferably, the communication network described herein may be the Internet or the World Wide Web (WWW). However, the communication network is not necessarily limited thereto, and may at least partially include known wired/wireless data communication networks, known telephone networks, or known wired/wireless television communication networks.

For example, the communication network may be a wireless data communication network, at least a part of which may be implemented with a conventional communication scheme such as radio frequency (RF) communication, WiFi communication, cellular communication (e.g., Long Term Evolution (LTE) communication), Bluetooth communication (more specifically, Bluetooth Low Energy (BLE) communication), infrared communication, and ultrasonic communication.

Next, the plurality of nodes 100 according to one embodiment of the invention are points of contact or connection that may communicate with each other via the communication network, and may encompass physical nodes based on a server, a computer, a laptop, a smart phone, a tablet PC, and the like (i.e., digital equipment having a memory means and a microprocessor for computing capabilities) or logical nodes based on an application, a program module, a virtual machine, and the like (i.e., virtual nodes).

Meanwhile, the plurality of nodes 100 according to one embodiment of the invention may include an authentication management system for performing non-face-to-face authentication based on a blockchain network according to the invention, in the form of a program module such as an application or a widget. Further, the program module may be downloaded from an external application distribution server (not shown), an external system (not shown), or the like.

The blockchain network according to one embodiment of the invention may allow the plurality of nodes 100 participating in the network to jointly verify information to be stored in the network, and may record and share the verified information in the network, thereby ensuring the integrity and reliability of the recorded information without relying on certified third parties. For example, according to one embodiment of the invention, at least a part of the characteristics of the blockchain network may be similar to those of a conventional blockchain network based on Bitcoin, Ethereum, Quantum, or the like. Further, according to one embodiment of the invention, the blockchain network may encompass various types of blockchain networks such as a private blockchain network, a public blockchain network, or a combination of private and public blockchain networks.

Further, the blockchain network according to one embodiment of the invention may issue and distribute cryptocurrency for operation, management, and the like of the network.

For example, the cryptocurrency according to one embodiment of the invention may be generated on the basis of the Ethereum token standard (i.e., ERC-20) or Quantum token standard (i.e., QRC, a Quantum's counterpart of ERC-20).

Next, the authentication management system according to one embodiment of the invention may function to provide an authenticatee node 110 with authentication result information generated as face-to-face authentication for personal information of an authenticatee is performed by at least one authenticator node 120 in the blockchain network, and to match and record non-invertible operation information on at least a part of the authentication result information to an account associated with the authenticatee in the blockchain network.

Further, the authentication management system according to one embodiment of the invention may function to, when a request for non-face-to-face authentication of the authenticatee is made by an authentication requester node 130, verify validity of information for authentication, which is provided from the authentication requester node 130 for the request for the non-face-to-face authentication of the authenticatee, on the basis of the non-invertible operation information recorded in the blockchain network.

Meanwhile, the authentication management system according to one embodiment of the invention may generate the non-invertible operation information by employing a known technique related to non-invertible transformation, such as a hash function, a hash operation, and a cryptography algorithm.

The configurations and functions of the authentication management system according to the invention will be discussed in more detail below. Meanwhile, although the authentication management system has been described as above, the above description is illustrative and it will be apparent to those skilled in the art that at least a part of the functions or components required for the authentication management system may be implemented or included in the plurality of nodes 100 or an external system (not shown), as necessary. For example, according to one embodiment of the invention, the authenticatee, authenticator, or authentication requester may perform authentication according to the invention by using an application including at least a part of the functions of the authentication management system (or blockchain network) according to the invention through his/her node, or connecting to a website providing at least a part of the functions of the authentication management system (or blockchain network) according to the invention using his/her node.

Configuration of the Authentication Management System

Hereinafter, the functions of the respective components of the authentication management system crucial for implementing the invention will be discussed.

The authentication management system according to one embodiment of the invention may comprise an authentication result information management unit and a non-face-to-face authentication management unit. According to one embodiment of the invention, at least some of the authentication result information management unit and the non-face-to-face authentication management unit may be program modules to communicate with an external system. The program modules may be included in the authentication management system in the form of operating systems, application program modules, and other program modules, while they may be physically stored in a variety of commonly known storage devices. Further, the program modules may also be stored in a remote storage device that may communicate with the authentication management system. Meanwhile, such program modules may include, but not limited to, routines, subroutines, programs, objects, components, data structures, and the like for performing specific tasks or executing specific abstract data types as will be described below in accordance with the invention.

First, the authentication result information management unit according to one embodiment of the invention may function to match and record non-invertible operation information on at least a part of authentication result information, which is generated as face-to-face authentication for personal information of an authenticatee is performed by at least one authenticator node 120 in a blockchain network, to an account associated with the authenticatee in the blockchain network. The personal information according to one embodiment of the invention is information by which an authenticatee is identified or distinguished from another authenticatee, and may include information on at least one of a resident registration number, phone number, name, sex, birthday, address, and e-mail of the authenticatee. Further, the authentication result information according to one embodiment of the invention may be generated on the basis of at least one of information on an account associated with an authenticatee in the blockchain network (e.g., a blockchain network account of the authenticatee), personal information (e.g., a name, resident registration number, etc.) of an authenticatee who is identified or verified face-to-face by an authenticator, identification information on an authenticatee managed by the authenticator node 120 (e.g., a management number assigned to the authenticatee by an internal system of the authenticator node 120), information on an account associated with an authenticator in the blockchain network (e.g., a blockchain network account of the authenticator), and electronic signature information of an authenticator (e.g., electronic signature information encrypted and generated with a private key of the authenticator). In addition, the account according to one embodiment of the invention is digital information having uniqueness managed by the blockchain network, and may be composed of at least one of characters, symbols, and numbers. For example, the account according to one embodiment of the invention may include a public key managed by the blockchain network or an address (or a hash value corresponding to the address) of a cryptocurrency wallet.

For example, according to one embodiment of the invention, when face-to-face (or offline) authentication for personal information of an authenticatee is performed by an authenticator (e.g., the authentication is performed such that the authenticator actually meets the authenticatee and personally checks an identification card, face, and the like of the authenticatee to verify that the personal information of the authenticatee is true), the authentication result information management unit may generate authentication result information as a result of performing the authentication of the authenticatee, and may match and record non-invertible operation information, which is generated by a non-invertible operation on the personal information of the authenticatee authenticated face-to-face by the authenticator and information on an account associated with the authenticatee in the blockchain network among the authentication result information, to the account of the authenticatee in the blockchain network.

Further, according to one embodiment of the invention, when face-to-face authentication for personal information of an authenticatee is performed by a plurality of authenticator nodes 120, non-invertible operation information on at least a part of respective authentication result information generated as the face-to-face authentication is performed may be matched and recorded to an account associated with the authenticatee in the blockchain network.

Specifically, the authentication result information management unit according to one embodiment of the invention may match and record non-invertible operation information on at least a part of authentication result information generated as face-to-face authentication for personal information of an authenticatee is performed by a first authenticator node, and non-invertible operation information on at least a part of authentication result information generated as face-to-face authentication for the personal information of the authenticatee is performed by a second authenticator node, to an account associated with the authenticatee in the blockchain network, respectively.

That is, when face-to-face authentication of the personal information of the authenticatee is performed multiple times, non-invertible operation information (i.e., non-invertible operation information on at least a part of authentication result information generated as face-to-face authentication for the personal information of the authenticatee is performed) may be accumulated and recorded to the account associated with the authenticatee.

Meanwhile, the authentication result information management unit according to one embodiment of the invention may record the non-invertible operation information in the blockchain network with respect to each of predetermined transactions or blocks based on known blockchain technology.

Further, the authentication result information management unit according to one embodiment of the invention may record the non-invertible operation information (i.e., non-invertible operation information on at least a part of authentication result information) in the blockchain network after it is verified in the blockchain network by a known consensus algorithm such as proof-of-work (PoW), proof-of-stake (PoS), and delegated proof of stake (DPoS).

In addition, the authentication result information management unit according to one embodiment of the invention may function to provide at least a part (or at least one) of the authentication result information and the non-invertible operation information to the authenticatee node 110.

For example, the authentication result information management unit according to one embodiment of the invention may store or record at least a part (or at least one) of the authentication result information and the non-invertible operation information in the authenticatee node 110. According to one embodiment of the invention, the characteristics or purposes of the authentication result information and the non-invertible operation information stored or recorded in the authenticatee node 110 may be similar to those of an electronic certificate issued by a conventional authentication institution.

Meanwhile, the authentication result information management unit according to one embodiment of the invention may also provide the authentication result information and the non-invertible operation information to another node (e.g., a cloud or server) (not shown) that may be controlled by the authenticatee. In this case, the authentication result information and the non-invertible operation information may not be provided to the authenticatee node 110, if necessary.

Next, when a request for non-face-to-face authentication of the authenticatee is made by the authentication requester node 130, the non-face-to-face authentication management unit according to one embodiment of the invention may function to verify validity of information for authentication, which is provided from the authentication requester node 130 for the request for the non-face-to-face authentication of the authenticatee, on the basis of the non-invertible operation information recorded in the blockchain network. The authentication requester node 130 according to one embodiment of the invention is a node that requests or performs the non-face-to-face authentication of the authenticatee in the blockchain network, and may check or verify the personal information of the authenticatee non-face-to-face in order to perform a predetermined task (e.g., a bank account opening) requested from the authenticatee. In some cases, the authentication requester node 130 may be the same as the authenticatee node 110. According to one embodiment of the invention, the information for authentication may include at least a part (or at least one) of the authentication result information and the non-invertible operation information, and may refer to at least a part of the authentication result information that has been previously provided to the authenticatee by the authentication result information management unit and is provided from the authenticatee as a means for the non-face-to-face authentication.

For example, the non-face-to-face authentication management unit according to one embodiment of the invention may verify the validity of the information for authentication provided from the authentication requester node 130 (e.g., the information for authentication may be provided from the authenticatee node 110 to the authentication requester node 130) by comparing and analyzing non-invertible operation information on at least a part of the information for authentication provided from the authentication requester node 130 and the non-invertible operation information recorded in the blockchain network.

That is, according to one embodiment of the invention, the authenticatee may perform non-face-to-face authentication (e.g., self-authentication) by providing at least a part (or at least one) of the authentication result information and the non-invertible operation information previously provided to the authenticatee to several institutions (e.g., the authentication requester node 130) connected to the blockchain network so that it may be used similarly to a conventional electronic certificate, and the institutions performing the non-face-to-face authentication may verify whether the provided information for authentication has been forged or tampered through comparison with the non-invertible operation information recorded in the blockchain network.

Meanwhile, the non-face-to-face authentication management unit according to one embodiment of the invention may verify whether the authentication requester node 130 has rights for the account associated with the authenticatee, on the basis of a public key associated with the authenticatee. According to one embodiment of the invention, the public key may be information managed by the blockchain network. Further, according to one embodiment of the invention, the rights for the account may include rights regarding whether the authentication requester is the authenticatee, whether the authentication requester has rights to access the non-invertible operation information recorded in the blockchain, and the like.

For example, according to one embodiment of the invention, the non-face-to-face authentication management unit may send a random value to the authentication requester node 130 when the authentication requester node 130 is the same as the authenticatee node 110. When a signature encrypted with a private key of the authentication requester (i.e., the authenticatee) in correspondence to the random value is provided from the authentication requester node 130, the non-face-to-face authentication management unit may verify whether the authentication requester node 130 has rights for the account associated with the authenticatee by verifying whether the signature is normally decrypted using a public key of the authenticatee managed by the blockchain network.

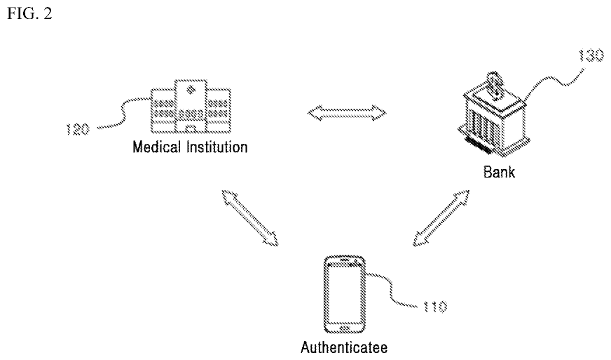

FIG. 2 illustratively shows a situation in which non-face-to-face authentication of an authenticatee is performed in a blockchain network according to one embodiment of the invention.

Referring to FIG. 2, according to one embodiment of the invention, it may be assumed that the authenticatee node 110, the authenticator node 120, and the authentication requester node 130 are connected to each other through the blockchain network, and the authenticator node 120 is a medical institution node and the authentication requester node 130 is a bank node. Further, the medical institution node (i.e., the authenticator node 120) according to one embodiment of the invention may include a node for an internal system (not shown) that manages medical information such as charts, diagnoses, and prescription history of patients, or may be a node that connects or interworks with the internal system node via the communication network. In addition, the bank node (i.e., the authentication requester node 130) according to one embodiment of the invention may include a node for an internal system (not shown) that manages financial information of customers, or may be a node that connects or interworks with the internal system node via the communication network.

First, according to one embodiment of the invention, face-to-face authentication of an authenticatee may be performed by a medical institution connected to a blockchain network as the authenticatee visits the medical institution for treatment purposes.

Next, according to one embodiment of the invention, authentication result information generated as face-to-face authentication for personal information of the authenticatee is performed by the medical institution node (i.e., the authenticator node 120) may be provided to the authenticatee node 110, and non-invertible operation information on at least a part of the authentication result information may be matched and recorded to an account associated with the authenticatee in the blockchain network.

Next, according to one embodiment of the invention, a request for non-face-to-face bank account opening may be made from the authenticatee node 110 to the bank node 130, and the authentication result information provided to the authenticatee node 110 may be provided from the authenticatee node 110 to the bank node 130 as information for authentication.

Next, according to one embodiment of the invention, when a request for non-face-to-face authentication of the authenticatee is made by the bank node 130 (e.g., the request is made for the purpose of identifying the authenticatee before proceeding with the bank account opening), validity of the information for authentication provided from the bank node 130 may be verified on the basis of the non-invertible operation information recorded in the blockchain network.

Next, according to one embodiment of the invention, when the information for authentication is verified to be valid, the bank node 130 may perform tasks related to the bank account opening of the authenticatee.

Meanwhile, according to one embodiment of the invention, it may be assumed that face-to-face authentication of an authenticatee is performed by a medical institution connected to the blockchain network as the authenticatee visits the medical institution, and face-to-face authentication of the authenticatee is performed by an insurance company connected to the blockchain network as the authenticatee further visits the insurance company.

That is, according to one embodiment of the invention, first authentication result information generated as face-to-face authentication for personal information of the authenticatee is performed by the medical institution node 120 may be provided to the authenticatee node 110, and non-invertible operation information on at least a part of the first authentication result information may be matched and recorded to an account associated with the authenticatee in the blockchain network. Next, according to one embodiment of the invention, second authentication result information generated as face-to-face authentication for the personal information of the authenticatee is performed by an insurance company node (not shown) may be provided to the authenticatee node 110, and non-invertible operation information on at least a part of the second authentication result information may be matched and recorded to the account associated with the authenticatee in the blockchain network.

Next, according to one embodiment of the invention, a request for non-face-to-face bank account opening may be made from the authenticatee node 110 to the bank node 130, and at least one of the first authentication result information and the second authentication result information provided to the authenticatee node 110 may be provided from the authenticatee node 110 to the bank node 130 as information for authentication. For example, at least one of the first authentication result information and the second authentication result information may be selectively provided to the bank node 130 by the authenticatee.

Next, according to one embodiment of the invention, when a request for non-face-to-face authentication of the authenticatee is made by the bank node 130 (e.g., the request is made for the purpose of identifying the authenticatee before proceeding with the bank account opening), validity of the information for authentication provided from the bank node 130 may be verified on the basis of the non-invertible operation information recorded in the blockchain network (e.g., the non-invertible operation information on at least a part of the first authentication result information and the non-invertible operation information on at least a part of the second authentication result information).

Next, according to one embodiment of the invention, when the information for authentication is verified to be valid, the bank node 130 may perform tasks related to the bank account opening of the authenticatee.

Meanwhile, the reliability for the non-face-to-face authentication may be evaluated to be higher as there are more authenticators (or authenticator nodes) having authenticated the authenticatee face-to-face in the blockchain network, or as the reliability of the authenticators is higher (e.g., the reliability of each medical institution or insurance company may be determined through a predetermined voting or consensus procedure performed by a plurality of nodes within the blockchain network). That is, the authenticatee may increase the reliability for the non-face-to-face authentication by providing the bank node 130 with authentication result information resulting from face-to-face authentication performed by an authenticator (or authenticator node) whose reliability is absolutely or relatively high, or providing the bank node 130 with respective authentication result information resulting from face-to-face authentication performed by a plurality of authenticators as much as possible. The reliability according to one embodiment of the invention may encompass an indicator of reputation or public trust associated with authentication in the blockchain network.

The embodiments according to the invention as described above may be implemented in the form of program instructions that can be executed by various computer components, and may be stored on a computer-readable recording medium. The computer-readable recording medium may include program instructions, data files, data structures and the like, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for supporting non-face-to-face authentication in a blockchain network, the method comprising the steps of:
providing an authenticatee node with authentication result information generated as face-to-face authentication for personal information of an authenticatee is performed by at least one authenticator node in a blockchain network, and matching and recording non-invertible operation information on at least a part of the authentication result information to an account associated with the authenticatee in the blockchain network; and
when a request for non-face-to-face authentication of the authenticatee is made by an authentication requester node, verifying validity of information for authentication, which is provided from the authentication requester node for the request for the non-face-to-face authentication of the authenticatee, on the basis of the non-invertible operation information recorded in the blockchain network.

2. The method of claim 1, wherein in the recording step, non-invertible operation information on at least a part of authentication result information generated as face-to-face authentication for the personal information of the authenticatee is performed by a first authenticator node, and non-invertible operation information on at least a part of authentication result information generated as face-to-face authentication for the personal information of the authenticatee is performed by a second authenticator node are matched and recorded to the account associated with the authenticatee in the blockchain network, respectively.

3. The method of claim 1, wherein in the verifying step, whether the authentication requester node has rights for the account associated with the authenticatee is verified using a public key associated with the authenticatee, and
wherein the public key is managed by the blockchain network.

4. The method of claim 3, wherein the verifying step comprises the steps of:
sending a random value to the authentication requester node; and
when a signature encrypted with a private key in correspondence to the random value is obtained from the authentication requester node, verifying whether the authentication requester node has rights for the account associated with the authenticatee by verifying whether the obtained signature is normally decrypted using the public key associated with the authenticatee.

5. The method of claim 1, wherein in the verifying step, the validity of the information for authentication provided from the authentication requester node is verified by comparing and analyzing non-invertible operation information on at least a part of the information for authentication and the non-invertible operation information recorded in the blockchain network.

6. The method of claim 1, wherein reliability for the non-face-to-face authentication is evaluated to be higher as there are more authenticators having performed face-to-face authentication for the personal information of the authenticatee, or as reliability of the authenticators having performed face-to-face authentication for the personal information of the authenticatee is higher.

7. A non-transitory computer-readable recording medium having stored thereon a computer program for executing the method of claim 1.

8. A system for supporting non-face-to-face authentication in a blockchain network, the system comprising:
an authentication result information management unit configured to provide an authenticatee node with authentication result information generated as face-to-face authentication for personal information of an authenticatee is performed by at least one authenticator node in a blockchain network, and to match and record non-invertible operation information on at least a part of the authentication result information to an account associated with the authenticatee in the blockchain network; and
a non-face-to-face authentication management unit configured to, when a request for non-face-to-face authentication of the authenticatee is made by an authentication requester node, verify validity of information for authentication, which is provided from the authentication requester node for the request for the non-face-to-face authentication of the authenticatee, on the basis of the non-invertible operation information recorded in the blockchain network.
